(19) United States
(12) Patent Application Publication
(10) Pub. No.: US 2014/0139997 A1
(43) Pub. Date: May 22, 2014

(54) INSTALLATION STRUCTURE OF DATA STORAGE DEVICE AND DATA STORAGE SYSTEM USING THE SAME

(71) Applicants: INVENTEC (PUDONG) TECHNOLOGY CORPORATION, (US); INVENTEC CORPORATION, Taipei (TW)

(72) Inventors: Chao-Chih Liu, Taipei (TW); Hsueh-Chan Li, Taipei (TW); Tsung-Hsin Hsieh, Taipei (TW)

(73) Assignees: INVENTEC CORPORATION, Taipei (TW); INVENTEC (PUDONG) TECHNOLOGY CORPORATION, Shanghai (CN)

(21) Appl. No.: 13/787,102

(22) Filed: Mar. 6, 2013

(30) Foreign Application Priority Data
Nov. 20, 2012 (CN) 201210472252.5

(51) Int. Cl. G06F 1/16

(52) U.S. Cl. CPC G06F 1/16
USPC 361/679.37

(57) ABSTRACT

An installation structure of a data storage device used for installing the data storage device in a case includes a frame, a pair of fastening portions and a pair of ring pulls. The frame includes a bottom and a pair of side walls. Each side wall has an outer surface facing the bottom rearwardly and an inner surface facing the bottom. The data storage device is accommodated between the bottom and the side walls. The pair of fastening portions is respectively connected with a pair of end portions of the pair of side walls, extended toward a direction further away from each side wall, and inclined toward a direction each outer surface faces. The pair of ring pulls is respectively connected with the pair of fastening portions, extended toward a direction further away from each side wall, and inclined toward a direction each of the inner surfaces faces.

### CROSS-REFERENCE TO RELATED APPLICATIONS

This non-provisional application claims priority under 35 U.S.C. §119(a) on Patent Application No(s). 201210472252.5 filed in China, P.R.C. on Nov. 20, 2012, the entire contents of which are hereby incorporated by reference.

### BACKGROUND OF THE INVENTION

1. Technical Field of the Invention

The disclosure relates to a data storage system, and more particularly to a data storage system having an installation structure of a data storage device.

2. Description of the Related Art

Nowadays, an computer device usually requires the disposition of data storage device for storing different data. It is common for user to use screws to directly lock and fix the data storage device in a case of the computer device. A plurality of data storage devices are usually arranged together in order that more data storage devices can be installed in a limited space.

However, such a design mentioned above requires the user to spend more time and use more complicated techniques for dismounting, replacing or adding a data storage device. Therefore, the user will have to turn the screws with a screwdriver in a limited space in order to install the data storage device in a case or dismount the data storage device from the case. Even though computer has become very popular nowadays, not everyone is highly skilled in operating tools. Such a design is rather inconvenient for users. Additionally, it is uneconomic in terms of disassembling the data storage device in such time-consuming manner.

### SUMMARY OF THE INVENTION

In an embodiment, the disclosure provides an installation structure of a data storage device configured for installing the data storage device in a case. The installation structure comprises a frame, a pair of fastening portions and a pair of ring pulls. The frame comprises a bottom and a pair of side walls. Each of the side walls has an outer surface facing the bottom rearwardly and an inner surface facing the bottom. The pair of side walls has a pair of end portions. A space between the bottom and the pair of side walls is configured for accommodating the data storage device. The pair of fastening portions is respectively connected with the pair of end portions of the pair of side walls. Each of the fastening portions extends toward a direction further away from each of the side walls and inclines toward a direction each of the outer surfaces facing. The pair of fastening portions is configured for fastening with the case. The pair of ring pulls is respectively connected with the pair of fastening portions. Each of the ring pulls extends toward a direction further away from each of the side walls and inclines toward a direction each of the inner surfaces facing. Each of the ring pulls is configured for driving each of the fastening portions to detach from fastening with the case.

Furthermore, the disclosure provides a data storage system comprises a data storage device, a case and an installation structure. The data storage device is installed in the case through the installation structure. The installation structure comprises a frame, a pair of fastening portions and a pair of ring pulls. The frame comprises a bottom and a pair of side walls. Each of the side walls has an outer surface facing the bottom rearwardly and an inner surface facing the bottom. The data storage device is accommodated between the bottom and the pair of side walls. The pair of fastening portions is respectively connected with a pair of end portions of the pair of side walls. Each of the fastening portions extends toward a direction further away from each of the side walls and inclines toward a direction each of the outer surfaces facing. The pair of fastening portions fastens with the case. The pair of ring pulls is respectively connected with the pair of fastening portions. Each of the ring pulls extends toward a direction further away from each of the side walls and inclines toward a direction each of the inner surfaces facing. Each of the ring pulls is configured for driving each of the fastening portions to detach from fastening with the case.

### BRIEF DESCRIPTION OF THE DRAWINGS

The disclosure will become more fully understood from the detailed description given herein below for illustration only, and thus does not limit the disclosure, wherein:

FIG. 1 is a perspective view of a data storage system according to an embodiment of the disclosure;

FIG. 2 is an exploded perspective view of a data storage device and an installation structure in FIG. 1; and

FIGS. 3A to 3D are top views of the data storage system in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

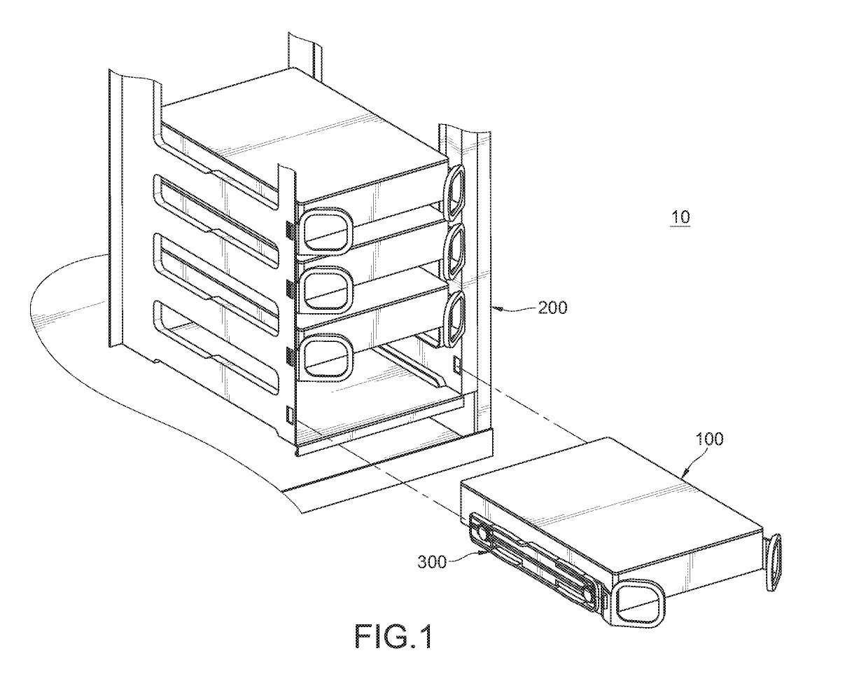

Please refer to FIG. 1. FIG. 1 is a perspective view of a data storage system 10 according to an embodiment of the disclosure. The data storage system 10 of the disclosure comprises a data storage device 100, a case 200 and an installation structure 300. The data storage device 100 is installed in the case 200 through the installation structure 300 of the data storage device 100. The case 200 is configured for placing at least one of the data storage devices 100.

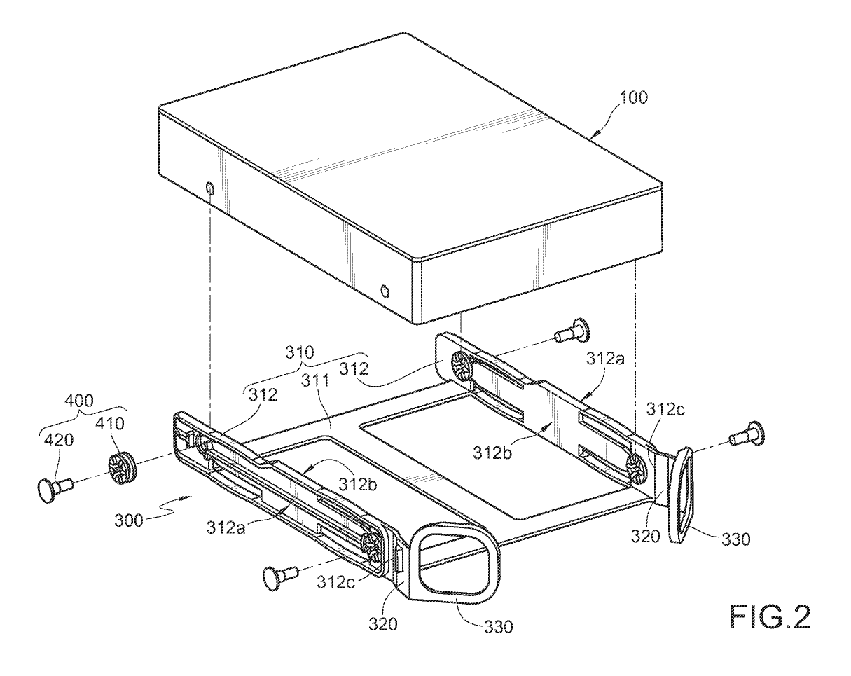

Please refer to FIG. 2 at the same time. FIG. 2 is an exploded perspective view of the data storage device 100 and the installation structure 300 in FIG. 1. The installation structure 300 comprises a frame 310, a pair of fastening portions 320 and a pair of ring pulls 330. The frame 310 comprises a bottom 311 and a pair of side walls 312. Each of the side walls 312 has an outer surface 312a facing the bottom 311 rearwardly and an inner surface 312b facing the bottom 311. The inner surface 312b of each of the side walls 312 faces each other oppositely. The data storage device 100 is accommodated between the bottom 311 and the pair of side walls 312. Each of the fastening portions 320 is respectively connected with an end portion 312c of each of the side walls 312. Each of the ring pulls 330 is respectively connected with each of the fastening portions 320. In this embodiment, the fastening portions 320 and the ring pulls 330 are made of flexible materials. When the fastening portions 320 and the ring pulls 330 are applied with an external force, the fastening portions 320 can turn relative to the side walls 312, and the ring pulls 330 can turn relative to fastening portions 320.

In this embodiment, the data storage system 10 further comprises a plurality of fixing elements 400 disposed in the pair of side walls 312. The fixing elements 400 fix the data storage device 100 between the side walls 312. Each of the fixing elements 400 comprises an elastic element 410 and a screw 420. Each of the elastic elements 410 penetrates through the side walls 312, and the screws 420 penetrate through the elastic elements 410 and the side walls 312 in order to lock and secure the data storage device 100 on the side walls 312. In other embodiments, each of the fixing elements 400 comprises a protruding piece for interfering with a concave portion of the data storage device 100 in order to fix the data storage device 100 on the side walls 312.

The data storage device 100 is fixed on the side walls 312 of the installation structure 300, and the fastening portions 320 of the installation structure 300 are fastened in fastening holes 210 of the case 200. Thereby, the data storage device 100 may be installed inside the case 200.

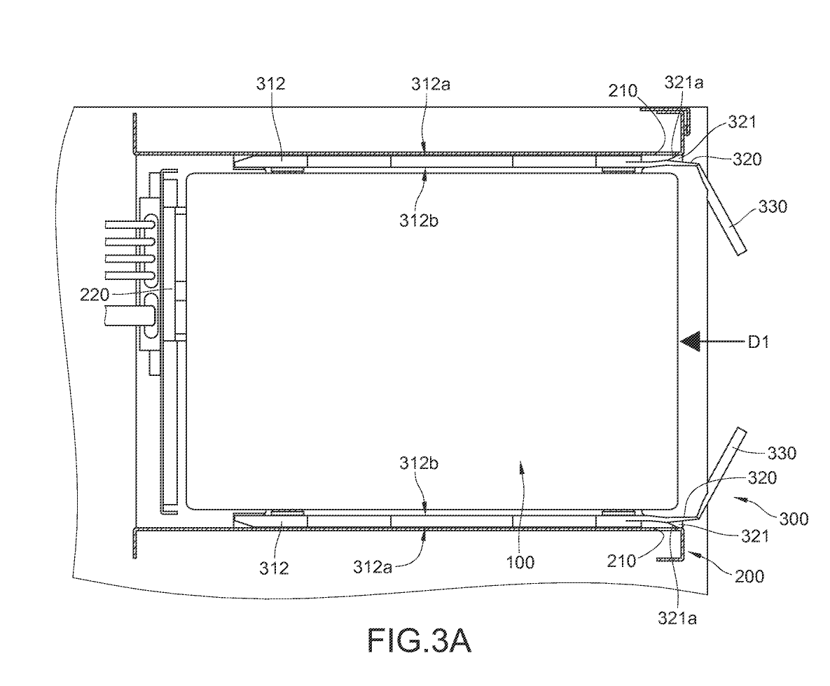

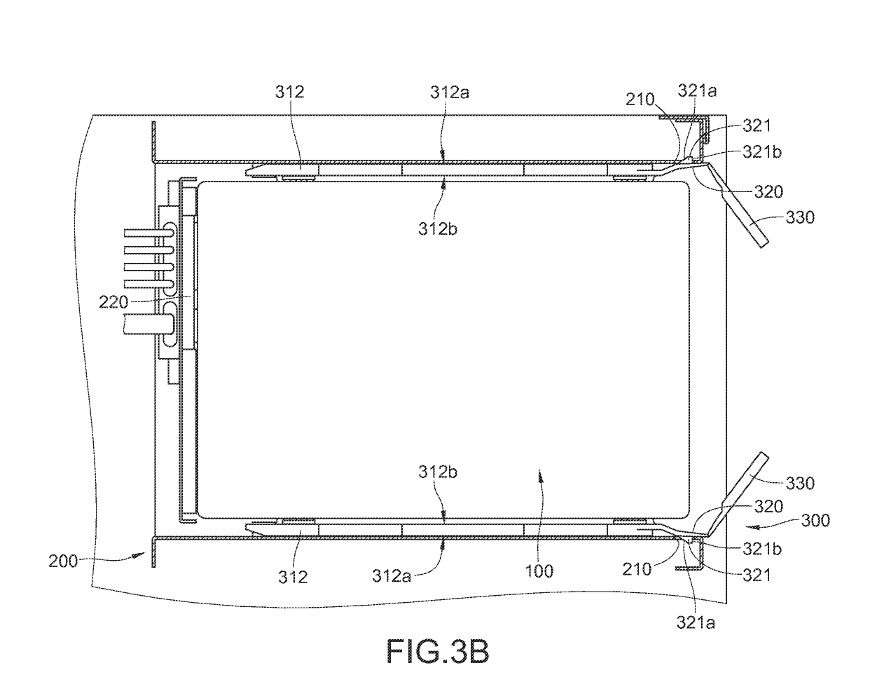

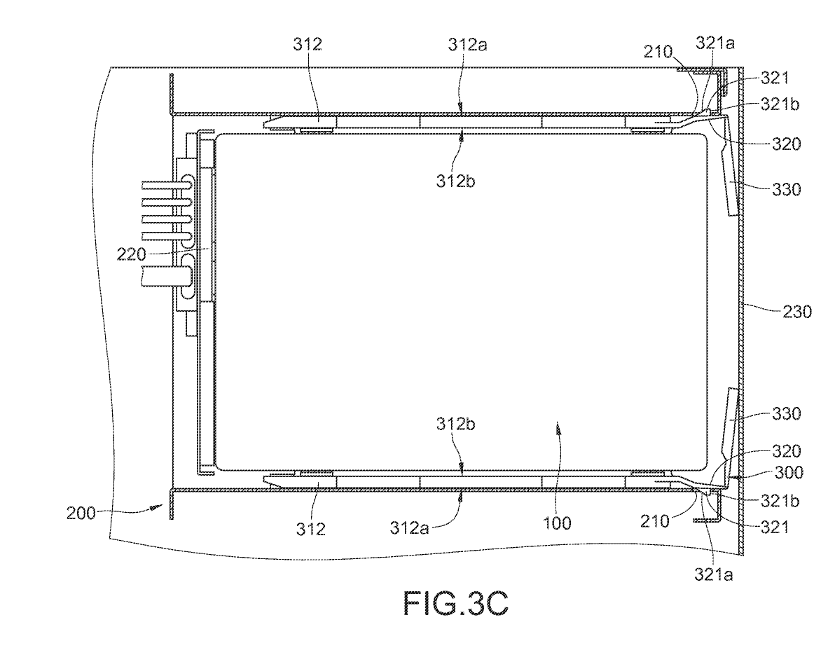

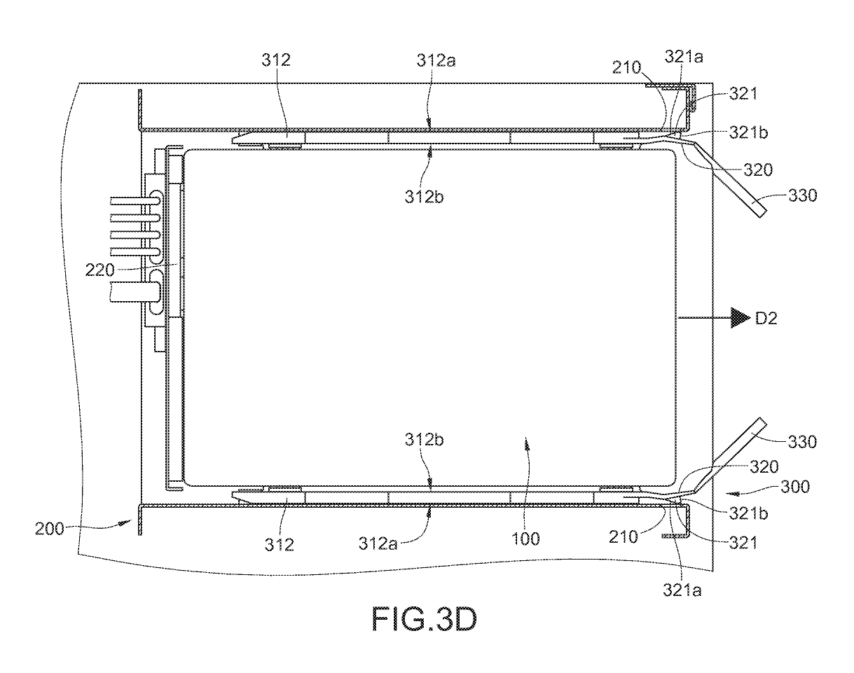

Please refer to FIGS. 3A to 3D. FIGS. 3A to 3D are top views of the data storage system 10 in FIG. 1. As shown in FIGS. 3A to 3D, each of the fastening portions 320 is extended toward a direction further away from each of the side walls 312, and is inclined toward a direction each of the outer surfaces 312a faces. The pair of fastening portions 320 are configured for being fastened with the case 200. Each of the ring pulls 330 is extended toward a direction further away from each of the side walls 312, and is inclined toward a direction each of the inner surfaces 312b faces. Each of the ring pulls 330 are configured for driving the fastening portions 320 to detach from fastening with the case 200.

In this embodiment, the case 200 has a pair of fastening holes 210. Each of the fastening portions 320 has a fastening protruded piece 321. Each of the fastening protruded pieces 321 has a slant surface 321a and an interfering surface 321b. Each of the slant surfaces 321a is nearer to each of the side walls 312 than each of the interfering surfaces 321b. As shown in FIG. 3A, when the installation structure 300 is installed in the case 200 along an installing direction Dl, each of the slant surfaces 321a of each of the fastening protruded pieces 321 can slide relative to the case 200. At this point, each of the fastening portions 320 can turn slightly toward a direction each of the inner surfaces 312b faces relative to each of the side walls 312 to cause the installation structure 300 to move toward the inside of the case 200 along the installing direction Dl. As shown in FIG. 3B, each of the interfering surfaces 321b can interfere and fasten with each of the fastening holes 210 of the case 200.

As shown in FIGS. 3A and 3B, the fastening holes 210 are disposed on an edge of the case 200. The installation structure 300 is also disposed on the edge of the case 200. At this point, a part of each of the ring pulls 330 is outside the case 200. The case 200 further comprises a connection port 220 for being electrically connected to the data storage device 100.

As shown in FIG. 3C, the case 200 further comprises an outer shell 230. The outer shell 230 is configured for covering the data storage device 100 and the installation structure 300. When the outer shell 230 covers the data storage device 100 and the installation structure 300, the outer shell 230 can press against the parts of the ring pulls 330 outside the case 200. Since each of the ring pulls 330 made of the flexible material is extended toward a direction further away from each of the side walls 312, and is inclined toward a direction each of the inner surfaces 312b faces, the outer shell 230 is configured for causing each of the ring pulls 330 to turn toward the side walls 312 relative to the fastening portions 320 when the outer shell 230 presses against the ring pulls 330.

As shown in FIG. 3B, when the outer shell 230 is opened, the ring pulls 330 are partially outside the case 200 for the user to hold on the ring pulls 330. As shown in FIG. 3D, when the installation structure 300 needs to be taken out from the case 200, simply hold on the ring pulls 330 and pull the pair of ring pulls 330 toward each other, or pull the ring pulls 330 along a straight dismounting direction D2. Thereby, each of the fastening portions 320 can be turned toward a direction each of the inner surfaces 312b faces relative to each of the side walls 312. Therefore, the fastening portions 320 can be moved away from the fastening holes 210 and detached from fastening with the case 200. Then, continue to pull the ring pulls 330 toward the dismounting direction D2 in order that the data storage device 100 fixed by the installation structure 300 can be detached from the case 200.

As a conclusion from the above mentioned descriptions of the installation structure and the data storage system using the installation structure of the disclosure, the data storage device may be accommodated between the bottom and the side walls of the installation structure outside the case beforehand. Then, the installation structure accommodated with the data storage device is installed in the case, and the fastening portions are fastened with the case. When the data storage device needs to be dismounted from the case, simply pull the ring pulls to drive the fastening portions to detach from fastening with the case in order to dismount the installation structure from the case. Then, the data storage device may be dismounted from the installation structure. Therefore, the user is able to speedily and conveniently install the data storage device in the case through the installation structure, or dismount the data storage device from the case.

What is claimed is:

1. An installation structure of a data storage device configured for installing the data storage device in a case, the installation structure comprising:
a frame comprising a bottom and a pair of side walls, each of the side walls having an outer surface facing the bottom rearwardly and an inner surface facing the bottom, the pair of side walls having a pair of end portions, a space between the bottom and the pair of side walls being configured for accommodating the data storage device;
a pair of fastening portions being respectively connected with the pair of end portions of the pair of side walls, each of the fastening portions extending toward a direction further away from each of the side walls and inclining toward a direction each of the outer surfaces facing, the pair of fastening portions being configured for fastening with the case; and
a pair of ring pulls being respectively connected with the pair of fastening portions, each of the ring pulls extending toward a direction further away from each of the side walls and inclining toward a direction each of the inner surfaces facing, each of the ring pulls being configured for driving each of the fastening portions to detach from fastening with the case.

2. The installation structure of the data storage device as claimed in claim 1, wherein each of the fastening portions has a fastening protruded piece, each of the fastening protruded pieces has a slant surface and an interfering surface, each of the slant surfaces is nearer to each of the side walls than each of the interfering surfaces, each of the slant surfaces is configured for sliding along the case relative to the case when the installation structure is installed in the case, and each of the interfering surfaces is configured for interfering with the case to fasten with the case.

3. The installation structure of the data storage device as claimed in claim 1, further comprising a fixing element disposed in one of the pair of side walls, the fixing element being configured for fixing the data storage device on one of the pair of side walls.

4. The installation structure of the data storage device as claimed in claim 3, wherein the fixing element comprises an elastic element and a screw, the elastic element penetrates through one of the pair of side walls, the screw penetrates through the elastic element and one of the pair of side walls for locking and securing the data storage device on one of the pair of side walls.

5. The installation structure of the data storage device as claimed in claim 3, wherein the fixing element comprises a protruding piece, the protruding piece configured for interfering with a concave portion of the data storage device in order to fix the data storage device on one of the pair of side walls.

6. A data storage system, comprising:
a data storage device;
a case; and
an installation structure, the data storage device being installed in the case through the installation structure, the installation structure comprising:
a frame comprising a bottom and a pair of side walls, each of the side walls having an outer surface facing the bottom rearwardly and an inner surface facing the bottom, the data storage device being accommodated between the bottom and the pair of side walls;
a pair of fastening portions being respectively connected with a pair of end portions of the pair of side walls, each of the fastening portions extending toward a direction further away from each of the side walls and inclining toward a direction each of the outer surfaces facing, the pair of fastening portions fastening with the case; and
a pair of ring pulls being respectively connected with the pair of fastening portions, each of the ring pulls extending toward a direction further away from each of the side walls, and inclining toward a direction each of the inner surfaces facing, each of the ring pulls being configured for driving each of the fastening portions to detach from fastening with the case.

7. The data storage system as claimed in claim 6, wherein the case has a pair of fastening holes, each of the fastening portions has a fastening protruded piece, each of the fastening protruded pieces has a slant surface and an interfering surface, each of the slant surfaces is nearer to each of the side walls than each of the interfering surfaces, each of the slant surfaces is configured for sliding along the case relative to the case when the installation structure is installed in the case, each of the interfering surfaces interferes and fastens with each of the fastening holes of the case.

8. The data storage system as claimed in claim 6, further comprising a fixing element disposed in one of the pair of side walls, the fixing element fixing the data storage device on one of the pair of side walls.

9. The data storage system as claimed in claim 8, wherein the fixing element comprises an elastic element and a screw, the elastic element penetrates through one of the pair of side walls, the screw penetrates through the elastic element and one of the pair of side walls for locking and securing the data storage device on one of the pair of side walls.

10. The data storage system as claimed in claim 8, wherein the fixing element comprises a protruding piece, the protruding piece interferes with a concave portion of the data storage device for fixing the data storage device on one of the pair of side walls.
